(19) United States
(12) Patent Application Publication
(10) Pub. No.: US 2012/0067902 A1
(43) Pub. Date: Mar. 22, 2012

(54) Volcano chicken pan

(76) Inventor: Robert Maffei, Staten Island, NY (US)

(21) Appl. No.: 12/803,439

(22) Filed: Sep. 20, 2010

(51) Int. Cl. A47J 27/00; A47J 36/02

(52) U.S. Cl. 220/573.1

(57) ABSTRACT

This invention relates to a new and improved design for cooking Beer Can Chicken. It will be made of a disposable metallic aluminum foil pan which slides over a beer or soda can and is used for cooking a whole chicken in an upright position. The present invention relates to a disposable pan and more importantly a disposable pan made of a single, continuous piece of thin and flexible, yet durable (such as aluminum foil). This device will be used to support a beer or soda can for cooking a popular dish called “Beer Can Chicken”.

### FIELD OF THE INVENTION

The present invention is a new and improved design which relates to cooking chicken, and more particularly to cooking beer can chicken. My invention is made of a disposable aluminum foil pan which slides over a beer or soda can and provides stability to the can and keeps it from toppling over when the whole chicken is mounted on top. This pan has deep sides and a central tube upstanding upon the bottom and through which my invention slides over a beer or soda can. My invention is used once and then discarded.

### BACKGROUND OF THE INVENTION

Many devices exist for use in grilling, roasting, and or smoking poultry. A popular and very simple method of preparing poultry on a grill or in the oven is commonly known as “beer can chicken”, where an open can of beer is placed on a hot grill or in the oven and a whole chicken is mounted on the beer can such that the beer can is inserted into the hollow body cavity of the chicken and the chicken is maintained in an upright position. The heat from the grill or oven causes the beer in the can to steam and boil, thus marinating the interior of the chicken and providing a cooked chicken that is moist and full of flavor.

Though simple and effective, there are many drawbacks to cooking poultry over a beer can alone. For example, the beer can and whole chicken combination is top heavy and unstable. My invention provides stability and keeps the can from toppling over. When a beer can and whole chicken combination topples, the chicken can become soiled or contaminated, and the spilled beer may extinguish the fire within the grill or oven. My invention slides over a can of beer (or soda) keeping it from toppling over.

Secondly, with previous beer pan chicken cookers, the exterior surface of a beer can has coatings including paint and other finishes which may be toxic when coming in contact with the chicken. My invention is made of a clean metallic aluminum foil which holds the beer or soda can in place and keeps it from toppling over. My invention also keeps the chicken from actually touching the beer or soda can. The bird sits on top of the clean center tube.

Thirdly, in previous inventions, the chicken is not protected from the heat in any way so that the drippings from the chicken fall directly onto the heat source, causing localized flare-ups which can burn the outside of the bird. My invention protects the bird and its fatty juices from direct heat and flame.

Finally, previous beer can chicken devices need to be thoroughly cleaned after each use. These beer can chicken cooking devices are usually made of a material (metal or clay). These other devices can become stained and are very difficult to clean. The most important aspect of my invention is that it is disposable. My invention is made of a disposable cheap aluminum type metallic foil. Use my invention once and then discard it. There will be no need for cleaning my device. You use a brand new clean pan with every use.

A need exists for a simple device which will allow cooking of raw poultry by grilling, roasting and/or smoking while proving stability during the cooking process, allowing steam or juices to be infused into the internal cavity of the bird and protecting the exterior of the poultry from intense heat and flames during the cooking process. Years ago, people devised a way to cook a whole chicken in the oven or in the barbeque using a half-full can of beer. The beer is placed in the oven or on a barbeque and the internal cavity of the dressed whole chicken was inserted over the beer can. The beer can supported the chicken in an upright position (in the oven or on a barbeque) while it cooked. The steam created by the boiling beer, which poached the chicken from within, kept the chicken moist and added flavor. Using this method, various poultry cookers have been developed with a vertical support element containing a reservoir for liquid seasonings such as beer, soda and wine.

### SUMMARY OF THE INVENTION

The present invention provides an improved poultry cooking apparatus with no detachable components. The poultry cooking apparatus of the present invention has a collecting pan with a bottom plate and a perpendicular sidewall extending around the outer circumference thereof. The bottom plate and sidewall create an area of sufficient size and volume to collect the fatty juices secreted by the poultry when it is cooked.

A cylindrical tube is centrally positioned on the bottom plate and extends perpendicular thereto. The tube has an opening adapted at the bottom to receive a beer or soda can. The tube has an outer surface capable of supporting the poultry (with the help of the beer or soda can) in a vertical, upright position during cooking.

Because the poultry is cooked in a vertical, upright position, the fatty juices from the poultry drip into the collecting pan thus ensuring that the poultry is not cooked in its own fat. The rendering of the fatty juices from the poultry makes the cooked poultry Substantially fat-free when compared to poultry that is cooked in its own fat drippings.

Given the loss of fatty juices, to ensure that the cooked poultry is moist and flavorful, my pan slides over a halfway filled beer or soda can. The chicken is then mounted over the center tube.

While the chicken is cooking, the heat from the cooking element (oven or barbeque) causes the liquid from the beer or soda can to vaporize or turn into steam which penetrates into the internal cavity of the poultry adding moisture and flavor thereto. Additionally, the steam poaches the poultry and thus decreases the overall cooking time.

When cooking chicken and other poultry, it is not uncommon for the poultry to lose its moisture due to relatively long exposure of the poultry to high temperatures during the cooking process. An internal cavity for the poultry can be created prior to cooking. Thus, devices have been used in the past to act as a stand for the chicken and also allow for steam to be introduced into the cavity during cooking to prevent drying of the chicken. Another object is to provide a pan fabricated from metal foil, and having a central heat tube, the construction being such that the pan with heat tube applied may be nested with other similar pans in stacked condition by means of forming dies, so as to permit nesting and stacking of the pans after assemble.

Still a further object of the invention is to provide a merchandisable package for my Volcano Chicken Pan, which is adapted to be stacked for delivery or display purposes without damage to the product housed therein. It will also be noted that the structural details of my pan are such as to facilitate the nesting of a plurality of such pans for delivery or storage. The pans may be nested and stacked.

### BRIEF DESCRIPTION OF THE DRAWINGS

The invention will now be more particularly described, by way of example, with reference to the drawings in which:

FIG. 1. This shows the side view of my disposable foil pan illustrating the top of the central tube which a whole dressed chicken is mounted.

FIG. 2. This Shows a cut-a-way side view of my disposable foil pan illustrating the top central tube and the opening of the bottom of the central tube.

FIG. 3 Is the top side view of my disposable foil pan illustrating the central tube, the side walls and the base.

FIG. 4. Is a cut-a-way view of the central tube and the inside base.

FIG. 5. Shows the bottom view of my foil pan.

FIG. 6. Shows the top view of my foil pan.

### DETAILED DESCRIPTION

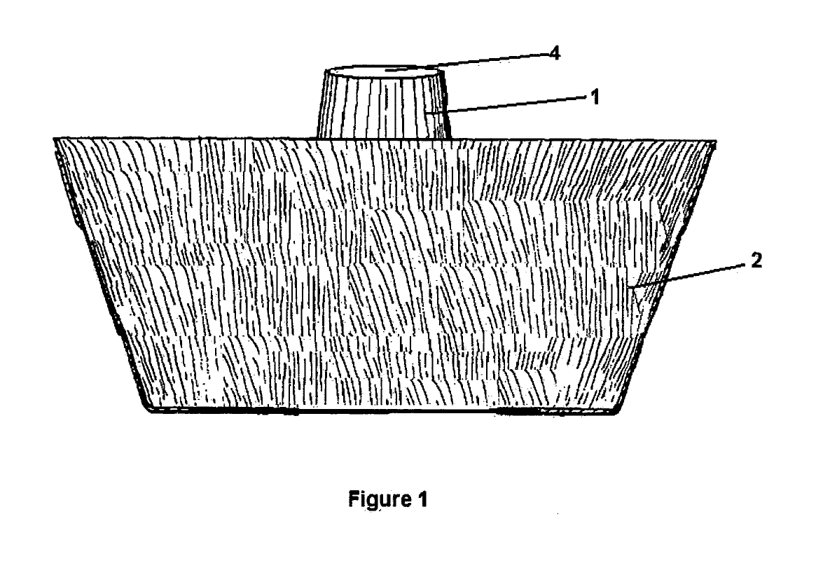

Referring now to FIG. 1, is a perspective side view of my disposable foil pan showing my new design which has a central tube (area 1) in which a whole chicken is mounted through its base cavity and sits atop the central tube. Steam escapes through opening in the top of the tube (area 4) and becomes absorbed by the chicken. Area 2 is the side wall of my pan.

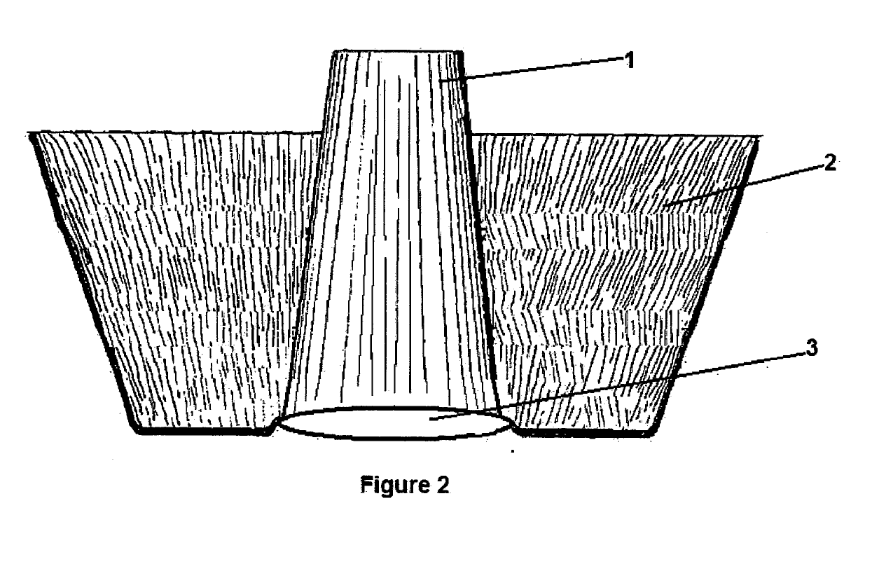

Referring now to FIG. 2, is a perspective cut-a-way side view of my disposable foil pan showing my new design which has a central tube (area 1) in which a whole chicken is mounted through its base cavity and sits atop the central tube. Area 2 is the side wall of my pan and area 3 is the base opening which slides over a beer or soda can.

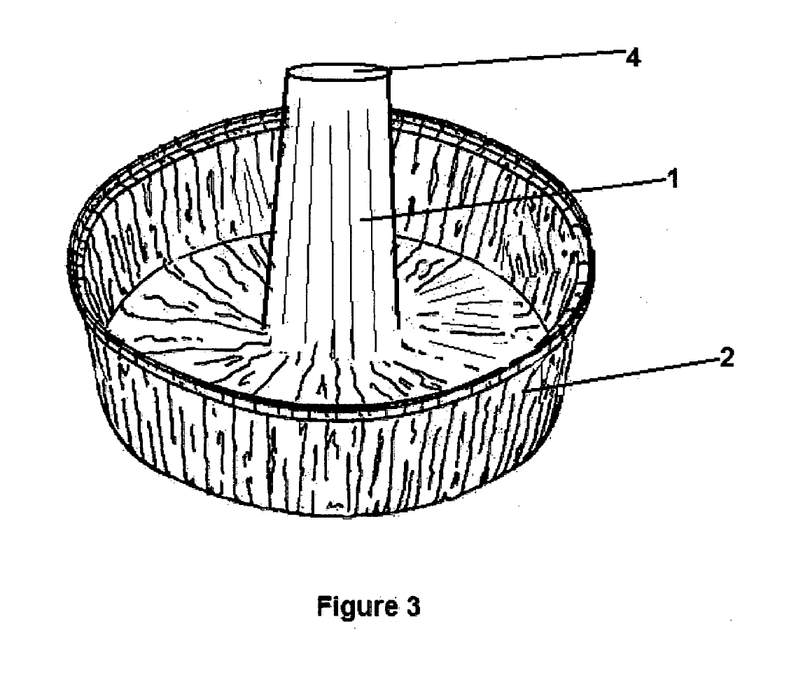

Referring now to FIG. 3, is a perspective top side view of my disposable foil pan showing my new design which has a central tube (area 1) in which a whole chicken is mounted through its base cavity and sits atop the central tube. Area 2 is the side wall of my pan. Steam escapes through opening in the top of the tube (area 4) and becomes absorbed by the chicken. the present invention may be formed by bending and folding a single continuous piece of foil between cooperating die portions on a press. While this may be referred to a drawing operation, it will be understood that due to the thinness of the foil which is used, there is substantially no stretching of the material to further reduce its thickness.

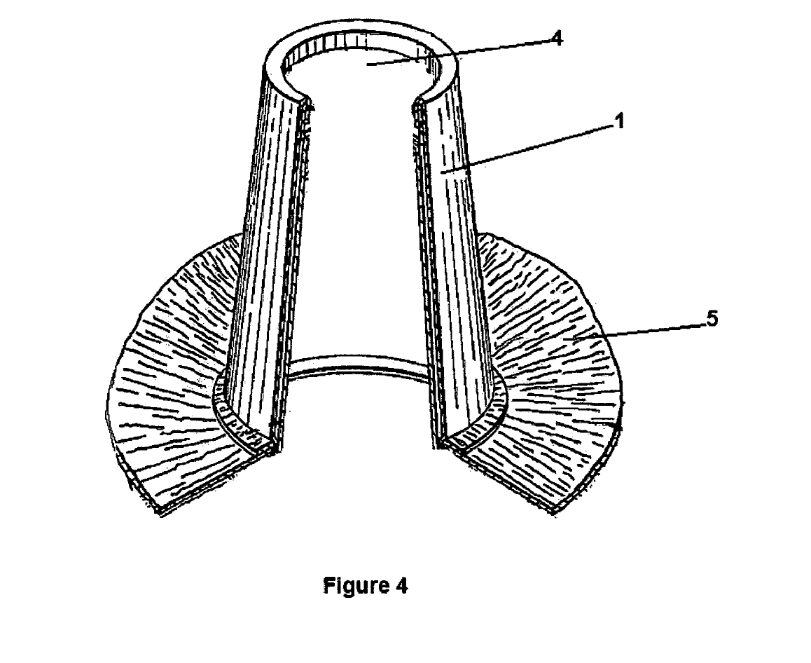

Referring now to FIG. 4, is a perspective cut-a-way view of area 1 which is the central heat tube in which a whole chicken is mounted through its base cavity and sits atop the central tube. Steam escapes through opening in the top of the tube (area 4) and becomes absorbed by the chicken Area 5 is the base of my pan.

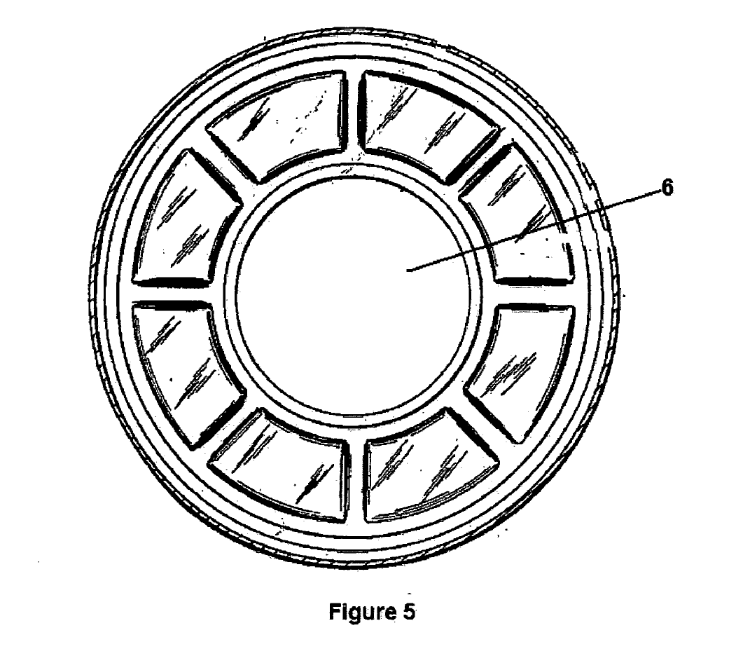

Referring now to FIG. 5, is a perspective bottom view (area 6) which is the opening at the base of my pan which is placed of a beer or soda can.

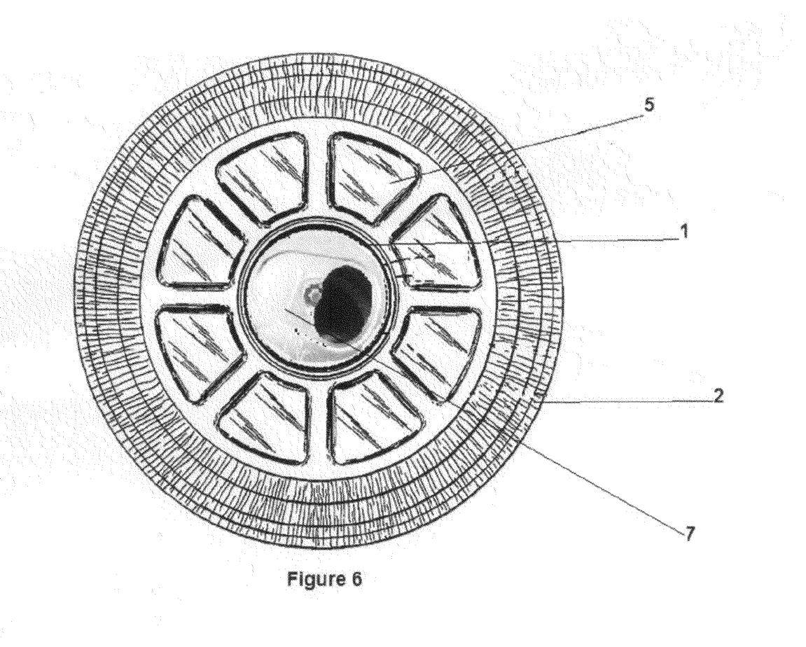

Referring now to FIG. 6, which is a perspective top view of my disposable foil pan showing my new design which has a drawing of a beer can (area 7) already inserted in the pans central tube (area 1). Area 2 is the side wall of my pan and area 5 is the base of my pan which collects the chicken juices.

What is claimed is:

1. This invention relates to a disposable metallic aluminum pan which slides over a beer or soda can and is concerned particularly with devices used for cooking beer can chicken. This pan has deep sides and a central tube through which my invention slides over a beer or soda can. My invention provides stability to the can and keeps it from toppling over. My pan supports the can from tipping over. The dressed whole chicken is mounted over the top area of the tube which is also supporting the can. The steam from the liquid in the can will cook the chicken from the inside while also keeping it juicy and moist. The most important aspect of my invention is that it is disposable. Most beer can chicken cooking devices in the market today are made of a material (clay/metal) which need to be thoroughly cleaned before using it again. The devices currently on the market can become discolored and stained. They are also very hard to clean because of its unique shape. My invention is made of a disposable aluminum type foil. My invention is used once and then discarded. It is a made of a cheap metallic disposable aluminum foil. No cleaning involved.

2. The present invention may be formed by bending and folding a single continuous piece of foil between cooperating die portions on a press. While this may be referred to a drawing operation, it will be understood that due to the thinness of the foil which is used, there is substantially no stretching of the material to further reduce its thickness.

3. Another object is to provide a light-weight but durable disposable pan constructed of inexpensive metallic foil which is utilized throughout the pans construction, including the cylindrical tube.

4. The present invention relates to a disposable pan and more importantly a disposable pan made of a single, continuous piece of thin and flexible, yet durable such as aluminum foil. This device will be used to support a beer or soda can for cooking a popular dish called “Beer Can Chicken”.
Various beer can chicken cooking devices have heretofore been made out of clay and/or metal but prior to the present invention, there has not been available a disposable aluminum foil type of device used for cooking beer can chicken.
My invention preferably will be made out of a extremely thin, light metal foil, such as aluminum foil of a gauge between 0.003″ and 0.0060″ in thickness and bent and folded into the desired shape. The primary object of the present invention is to provide a disposable pan of thin flexible material, such as thin aluminum foil, having a central tube (which slides over a can of beer or soda) formed, with the outer body portion of my pan, from a single, continuous piece of foil.

5. An integrated poultry cooking apparatus is providing having a collecting pan and a vertical tube permanently fixed thereto upon which the poultry is supported in an upright position during cooking.
The tube has a hollow top and a hollow bottom. The hollow bottom is placed over a beer or soda can. The hollow tube area also supports the can from tipping over. The chicken is then mounted over the hollow top area of the tube which is also supporting the can. The steam from the liquid in the can will cook the chicken from the inside while also keeping the bird juicy and moist.
During the cooking, the fatty juices in the poultry are secreted out of and away from the poultry because of its upright position and are collected in the collecting pan. The liquid in the can is vaporized and enter the poultry to replace the loss of the fatty juices and thereby maintain the moistness of the poultry while adding flavor.
